(19) United States
(12) Patent Application Publication
(10) Pub. No.: US 2026/0043297 A1
(43) Pub. Date: Feb. 12, 2026

(54) SELF-LOCKING BASE AND A TELESCOPIC DOOR RAILING HAVING THE SAME

(71) Applicant: GUANGZHOU TUSUNNY HOME PRODUCTS CO., LTD, Guangzhou (CN)

(72) Inventor: HONGJUAN WANG, Guangzhou (CN)

(21) Appl. No.: 18/919,621

(22) Filed: Oct. 18, 2024

(30) Foreign Application Priority Data
Aug. 9, 2024 (CN) 202421938128.8

(51) Int. Cl. E06B 9/171; E06B 9/00; E06B 9/13

(52) U.S. Cl. CPC E06B 9/171; E06B 9/13; E06B 2009/002

(57) ABSTRACT

The present invention discloses a self-locking base and a telescopic door railing having the same, and the self-locking base is pivotably provided with a pivot member that is fixedly connected to a rotating drum, and is also provided with a self-locking mechanism which locks the pivot member through the self-locking base when the pivot member rotates in the direction of curtain folding at or beyond a predetermined speed. Compared with traditional ones, effectively avoiding the injury to the human body caused by the swinging curtain during the automatic folding process, or damage to the curtain body caused by collision with hard or sharp objects during swinging.

### CROSS-REFERENCE TO RELATED APPLICATIONS

This application claims priority to Chinese Patent Application No. 202421938128.8, filed on Aug. 9, 2024, which is hereby incorporated by reference in its entirety.

### TECHNICAL FIELD

The present invention relates to the field of door railing technology, particularly to a self-locking base and a telescopic door railing having the same.

### BACKGROUND

Telescopic door railings are mostly used indoors or in courtyards to separate indoor or courtyard spaces, in order to create different temporary activity spaces for infants and young children to move around; specifically, telescopic door railings comprise a lock head, a base, a rotating drum, and a curtain body, and the rotating drum can be pivotably installed between the lock head and the base, and one end of the curtain body is disposed on the rotating drum, a torsion spring provided inside the rotating drum generates rotational elastic force to make the rotating drum rotate around its own axis in one direction, so that the rotating drum can fold the curtain body and the rotating drum that rotates in the direction of curtain unfolding can drive the torsion spring to compress and store force; when the rotating drum rotates in the direction of curtain unfolding, the torsion spring decompresses and releases elastic force to accelerate the pivot speed of the drum. In use, the end of the curtain can be grasped and pulled to unfold the curtain to an appropriate length before fixation.

The prior art mentioned above has some shortcomings: when the curtain body is unfolded with the end not fixed, releasing the end of curtain body will cause the curtain body to fold automatically at a faster speed due to the elastic force released by the torsion spring, easily causing injury to the human body especially when the curtain having any hard objects at its free end is swinging during the automatic folding process, or damage to the curtain body because of collision with hard or sharp objects during swinging.

### SUMMARY

The main objective of the present invention is to propose a self-locking base and a telescopic door railing having the same, aiming to address the shortcomings proposed in the background art mentioned above.

In order to achieve the above objectives, the present invention proposes a self-locking base, comprising:

a seat body;

a pivot member that is pivotably installed on the seat body and pivots relative to the seat body in the direction of curtain unfolding or folding;

a self-locking mechanism that is provided on the seat body for locking the pivot member when the pivot member pivots at or beyond a predetermined pivot speed in the direction of curtain unfolding.

Preferably, the seat body is provided with a top open accommodating cavity, the self-locking mechanism is disposed in the accommodating cavity, and the bottom of pivot member is pivotably installed in the accommodating cavity to close the top opening of accommodating cavity.

Preferably, the self-locking mechanism comprises a first ratchet groove, a first pawl, and a first elastic member that are disposed in the accommodating cavity;

the first pawl is rotatably mounted at a position on the bottom wall of pivot member corresponding to the first ratchet groove, and the first pawl swings relative to pivot member between the position where it is engaged with the first ratchet groove and the position where it is away from the first ratchet groove;

one end of the first elastic member is fixed, and the other end is connected to the free end of first pawl, and when the pivot member pivots in the direction of curtain folding at or beyond the predetermined pivot speed, the centrifugal force generated exceeds the load of the first elastic member, so that the first pawl swings to fit with the first ratchet groove to make the pivot member pivot in the direction of curtain folding, while causing local deformation of the first elastic member and applying elastic force to make the first pawl swing away from the direction of ratchet groove.

Preferably, the bottom wall of pivot member is pivotably installed with a pair of the first claws.

Preferably, an avoidance groove is provided between the two ends of the first pawl, and a holder is provided at the position on the bottom wall of pivot member corresponding to the avoidance groove, and one end of the first elastic member is connected to the holder, and the other end is connected to the free end of the first pawl.

Preferably, the bottom wall of pivot member is further provided with a pressing portion at the position corresponding to the avoidance groove, the holder is L-shaped, and the two sides of the first elastic member are respectively in contact with the holder and the pressing portion to fix the first elastic member.

Preferably, the free end of first pawl is provided with a slit for the movable insertion of the end of the first elastic member.

Preferably, the first elastic member is a strip shaped sheet structure.

The present invention proposes a telescopic door railing, comprising a lock head, a rotating drum having a torsion spring inside, and a curtain body with one end connected to the rotating drum, further comprising a self-locking base mentioned above, the rotating drum is pivotably installed between the lock head and the self-locking base and drives the pivot member to pivot synchronously, and the torsion spring pivots along with the rotating drum in the direction of curtain unfolding to compress and store force, pivots along with the rotating drum in the direction of curtain folding to decompress, and releases the stored force at the time of decompression to make the pivot member pivot at or beyond the predetermined pivot speed.

Preferably, the bottom of seat body is pivotably provided with a first ratchet and a swinging member, the first ratchet is connected to one end of the torsion spring and pivots relative to the seat body in the direction in which the torsion spring is compressed or decompressed, and the swinging member is pivotably installed at the bottom of the seat body and swings between the position where it is engaged with the first ratchet and the position where it is away from the first ratchet, and the swinging member engaging with the first ratchet limits the first ratchet to pivot in the direction in which elastic force is released to the torsion spring; in addition, a first top spring is provided to apply force to make swinging member swing towards the direction in which the swinging member is engaged with the first ratchet wheel, the first ratchet wheel pivoting in the direction in which torsion spring is compressed overcomes the elastic force applied by the first top spring to force the swinging member swing in the direction away from the first ratchet.

Preferably, an adjustment hole is provided on the side of the first ratchet wheel away from the pivot member.

Preferably, the swinging member is further provided with a driving arm that drives the swinging member to swing away from the first ratchet.

Preferably, the bottom of seat body is provided with an installation space for accommodating the first ratchet wheel, the swinging member, and the first top spring, and the first ratchet wheel is provided with a circular table having the adjustment hole, and a cover plate is installed on the seat body to close the installation space, and the cover plate is open at the position corresponding to the circular table and driving arm.

Preferably, a positioning member is fixed at a position inside the rotating drum above the pivot member, and the positioning member is pivotably provided with a sleeve that is fixedly connected to the rotating drum, and the two ends of the torsion spring are fixedly connected to the positioning member and pivot member, respectively.

Preferably, the seat body is provided with a positioning rod that is inserted into the rotating drum, and one end of seat body is fixed with the positioning member, and the end of positioning rod away from positioning member is fixedly connected to the first ratchet wheel.

Preferably, a vertical pole is further provided, the upper end of the vertical pole is connected to the lock head, the lower end of vertical pole is connected to the self-locking base, and the movable sleeve of vertical pole is provided with a sliding seat, and the back of sliding seat is detachably provided with a first plug board for fixed connection at the installation position.

Preferably, the lock head comprises a housing, a connecting head pivotably installed at the bottom, and a locking mechanism for locking the connecting head, the connecting head is fixedly connected to the upper end of rotating drum, and the locking mechanism comprises a knob pivotably installed on the housing, a second ratchet wheel fixedly connected to the connecting head, a second pawl pivotably installed on the housing, and a second top spring, and the second pawl swings, relative to the housing, between the position where the second pawl is engaged with the second ratchet wheel to lock the second ratchet wheel and the position where the second pawl is away from the second ratchet wheel, and the second top spring is used to apply elastic force to make the second pawl swing in the direction in which the second pawl is engaged with the second ratchet wheel, the knob is provided with a driving portion that swings along with the pivoting knob between the position where it is away from the second pawl and the position where the second pawl is away from the second ratchet wheel.

Preferably, the back of lock head is detachably provided with a second plug board for fixed connection with the installation position, and the lock head is movably installed with a moving block that moves relative to the lock head between the position where it is away from the second plug board and the position where it is inserted into the second plug board to restrict the detachment of second plug board from the lock head, and a third top spring is also provided to apply elastic force to make the moving block move in the direction in which moving block is inserted in the second plug board.

Preferably, a fixed structure is also provided, comprising a snap ring connected to the free end of the curtain body and a hook fixedly connected to the installation position, and after the curtain body is unfolded, the free end of curtain body is fixed through the fit between the snap ring and hook.

In the technical solution of the present invention, the self-locking base is pivotably provided with a pivot member that is fixedly connected to a rotating drum, and is also provided with a self-locking mechanism which locks the pivot member through the self-locking base when the pivot member rotates in the direction of curtain folding at or beyond a predetermined speed. Compared with traditional ones, the present invention adds a self-locking function on the basis of prior art, and when the rotating drum pivots in the direction of curtain folding, the torsion spring is decompressed to release elastic force to make the rotating drum and pivot member reach or exceed the predetermined speed, and to trigger the self-locking mechanism to lock the pivot member, thereby stopping the automatic folding of curtain body and effectively avoiding the injury to the human body caused by the swinging curtain during the automatic folding process, or damage to the curtain body caused by collision with hard or sharp objects during swinging.

### BRIEF DESCRIPTION OF DRAWINGS

FIG. 1 is a three-dimensional view of the self-locking base;

FIG. 2 is the first schematic diagram of the first embodiment of self-locking mechanism;

FIG. 3 is the second schematic diagram of the first embodiment of self-locking mechanism;

FIG. 4 is the first schematic diagram of the second embodiment of self-locking mechanism;

FIG. 5 is the second schematic diagram of the second embodiment of self-locking mechanism;

FIG. 6 is the third schematic diagram of the second embodiment of self-locking mechanism;

FIG. 7 is the first schematic diagram of the third embodiment of self-locking mechanism;

FIG. 8 is the second schematic diagram of the third embodiment of self-locking mechanism;

FIG. 9 is an assembly diagram of the first ratchet and swinging member;

FIG. 10 is a three-dimensional view of telescopic door railing;

FIG. 11 is a sectional view of telescopic door railing;

FIG. 12 is a partial exploded view of lock head.

### DESCRIPTION OF EMBODIMENTS

The technical solutions in the embodiments of the present invention will be described clearly and completely in conjunction with the accompanying drawings of the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

It should be noted that all directional indicators (such as up, down, left, right, front, rear, etc.) in the embodiments of the present invention are only used to explain the relative position relationship and movement among various components in a particular posture (as shown in the accompanying drawings), and if that particular posture is changed, the directional indications will change accordingly.

In addition, descriptions involving terms “first,” “second” and the like, if any, in the present invention are only for illustrative purposes and cannot be understood as indicating or implying relative importance or the number of features referred to. Therefore, the features defined with “first” and “second” may explicitly or implicitly include at least one or a plurality of the features. At the same time, the technical solutions of various embodiments can be combined with each other, but must be based on what those of ordinary skill in the art can achieve. The combination of technical solutions that result in contradiction or make it impossible to implement should be considered non-existent, and accordingly should not fall within the scope of protection required by this present invention.

The present invention proposes a self-locking base.

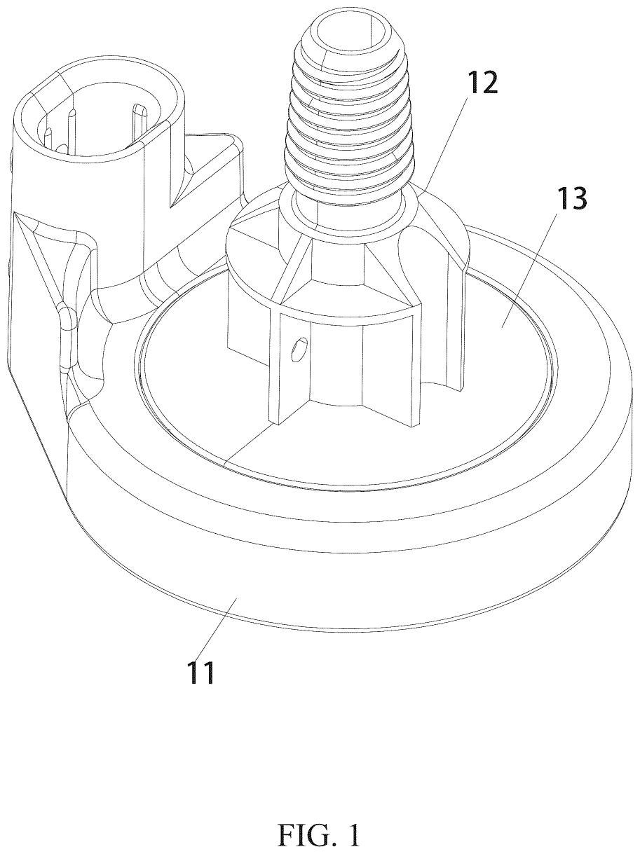

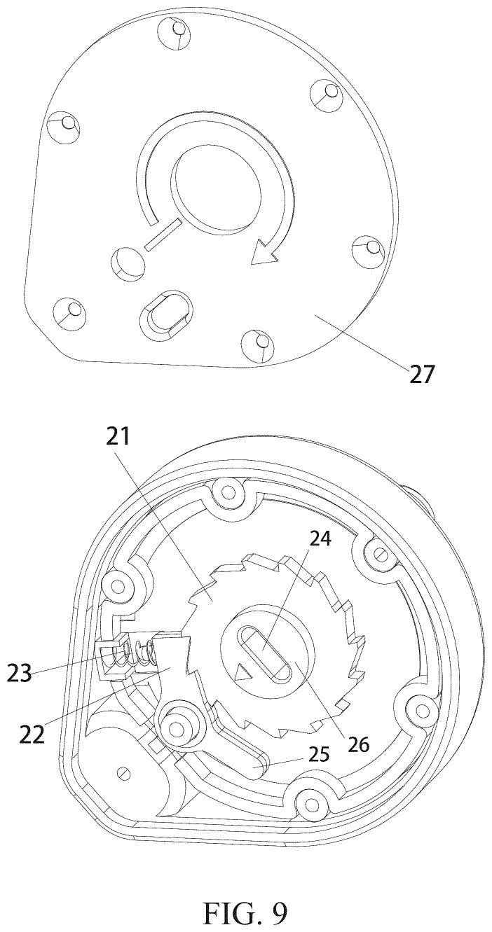

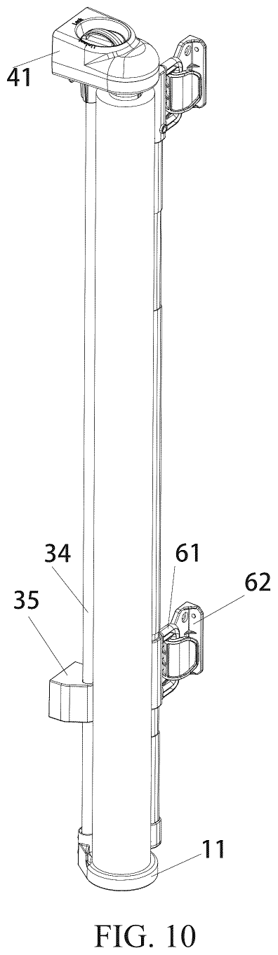

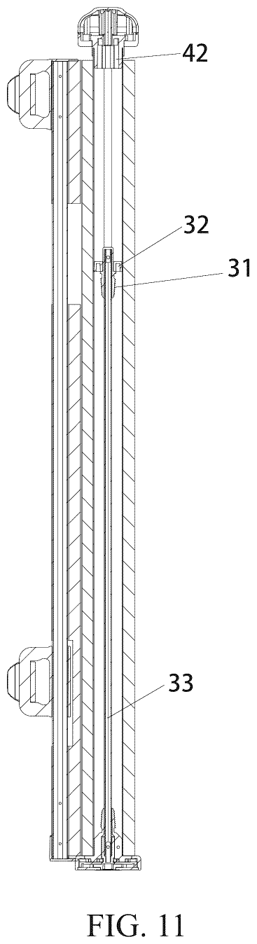

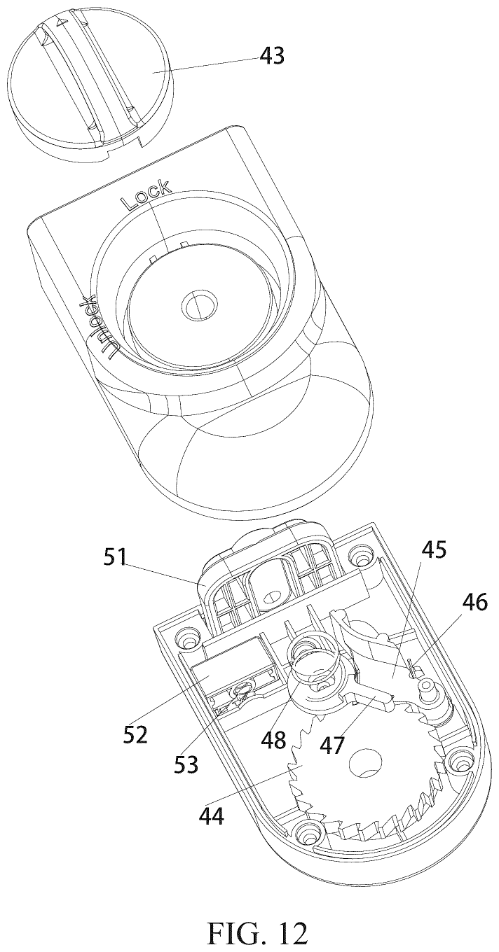

In the embodiments of the present invention, as shown in FIG. 1 to 12, the self-locking base comprises a seat body 11, a pivot member 12, and a self-locking mechanism.

The pivot member 12 is pivotably installed on the seat body 11 and pivots relative to the seat body 11 in the direction of curtain unfolding or folding; the self-locking mechanism is provided on the seat body for locking the pivot member 12 when the pivot member 12 pivots at or beyond a predetermined pivot speed in the direction of curtain unfolding.

Specifically, the seat body is provided with a top open accommodating cavity, the self-locking mechanism is disposed in the accommodating cavity, and the bottom of pivot member 12 is pivotably installed in the accommodating cavity to close the top opening of accommodating cavity.

Specifically, the accommodating cavity is circular, and the bottom of the pivot member 12 is provided with a circular plate 13 that matches the shape of the accommodating cavity.

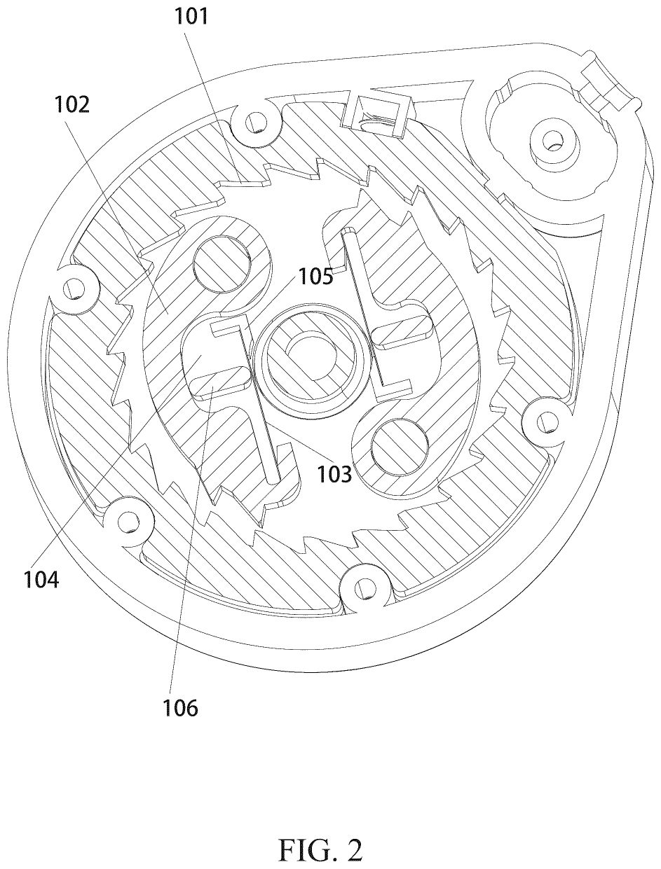

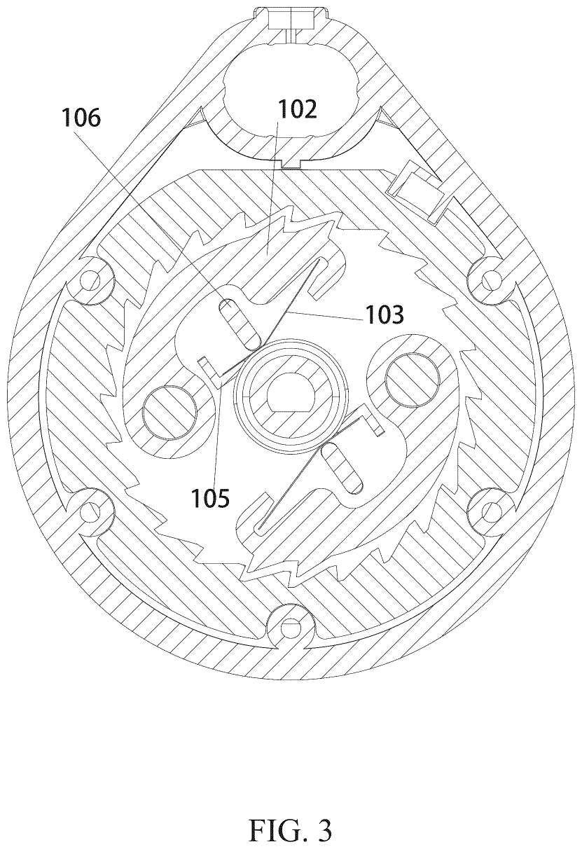

Specifically, the present invention provides three embodiments for the self-locking mechanism and in the first embodiment, as shown in FIGS. 2 and 3, the self-locking mechanism comprises a first ratchet groove 101, a first pawl 102, and a first elastic member 103 that are disposed in the accommodating cavity;

The first pawl 102 is rotatably mounted at a position on the bottom wall of pivot member 12 corresponding to the first ratchet groove 101, and the first pawl 102 swings relative to pivot member 12 between the position where it is engaged with the first ratchet groove 101 and the position where it is away from the first ratchet groove 101;

One end of the first elastic member 103 is fixed, and the other end is connected to the free end of first pawl 102, and when the pivot member 12 pivots in the direction of curtain folding at or beyond the predetermined pivot speed, the centrifugal force generated exceeds the load of the first elastic member 103, so that the first pawl 102 swings to fit with the first ratchet groove 101 to make the pivot member 12 pivot in the direction of curtain folding, while causing local deformation of the first elastic member 103 and applying elastic force to make the first pawl 102 swing away from the direction of ratchet groove.

The curtain body will fold successfully when the pivot member 12 slowly and uniformly pivots towards the direction of curtain unfolding to generate no centrifugal force or a small centrifugal force that is insufficient to exceed the load of the first elastic member 103 or to cause the first pawl 102 to swing.

When the pivot member 12 pivots in the direction of curtain unfolding, the first pawl 102 disengages from the first ratchet groove 101, so that the first elastic member 103 resets from deformation and simultaneously releases elastic force to make the first pawl 102 swing away from the first ratchet groove 101 until the elastic force generated by the first elastic member 103 disappears, thereby resetting the first pawl 102.

Specifically, the bottom wall of pivot member 12 is pivotably installed with a pair of the first claws 102 to enhance locking strength.

An avoidance groove 104 is provided between the two ends of the first pawl 102, and a holder 105 is provided at the position on the bottom wall of pivot member 12 corresponding to the avoidance groove 104, and one end of the first elastic member 103 is connected to the holder 105, and the other end is connected to the free end of the first pawl 102.

Specifically, the bottom wall of pivot member 12 is further provided with a pressing portion 106 at the position corresponding to the avoidance groove 104, the holder 105 is L-shaped, and the two sides of the first elastic member 103 are respectively in contact with the holder 105 and the pressing portion 106 to fix the first elastic member 103.

Specifically, the free end of first pawl 102 is provided with a slit for the movable insertion of the end of the first elastic member 103.

Specifically, the first elastic member 103 is a strip shaped sheet structure, preferably made of metal.

Specifically, a first annular member having the first ratchet groove 101 is also provided, and is locked by screws or fixed in the accommodating cavity through a buckle structure, alternatively, a plurality of first limit strips are spaced apart annularly inside the accommodating cavity for insertion with the first annular member, so that the first annular member is limited by a plurality of first limit strips to prevent the fit failure of first pawl 102 due to the first annular member's pivot action relative to the accommodating cavity.

Specifically, the first annular member is a sheet, preferably made of metal.

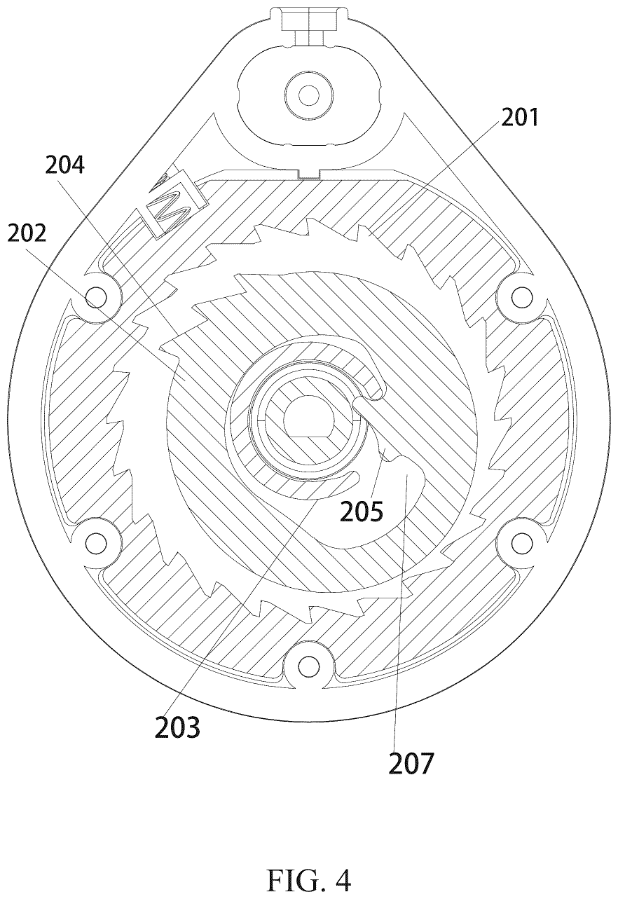

In the second embodiment, as shown in FIG. 4 to 6, the self-locking mechanism comprises a second ratchet groove 201, a moving piece 202, and a partially open driving ring 203 that are disposed in the accommodating cavity;

The driving ring 203 is located on the bottom wall of pivot member 12 and is coaxial with the pivot member 12;

The outer edge of moving piece 202 is provided with several locking teeth 204 that fit with the second ratchet groove 201, the moving piece 202 is movably disposed in the second ratchet groove 201 and moves between the position where the locking teeth 201 is engaged with the second ratchet groove 201 and the position where the locking teeth 201 is away from the second ratchet groove 201, and the moving piece 202 is also provided with a groove for the insertion of driving ring 203, the groove is provided with an arc-shaped portion 205 that passes through the opening of driving ring 203, and the two ends of the arc-shaped portion 205 fit with the inner wall of the groove to respectively form a first locking position 206 and a second locking position 207;

As shown in FIG. 4, the pivot member 12 pivoting in the direction of curtain unfolding drives one of the two ends of the driving ring 203 to enter the first lock position 206 and maintain contact to drive the moving piece 202 to move in the direction in which the second ratchet groove 201 exits the locking teeth 204 and partially contact the groove along with the local outer wall of driving ring 203, so that the moving piece 202 pivots in the direction of curtain unfolding together with the pivot member 12 in the state where the locking teeth 204 does not fit with the second ratchet groove 201;

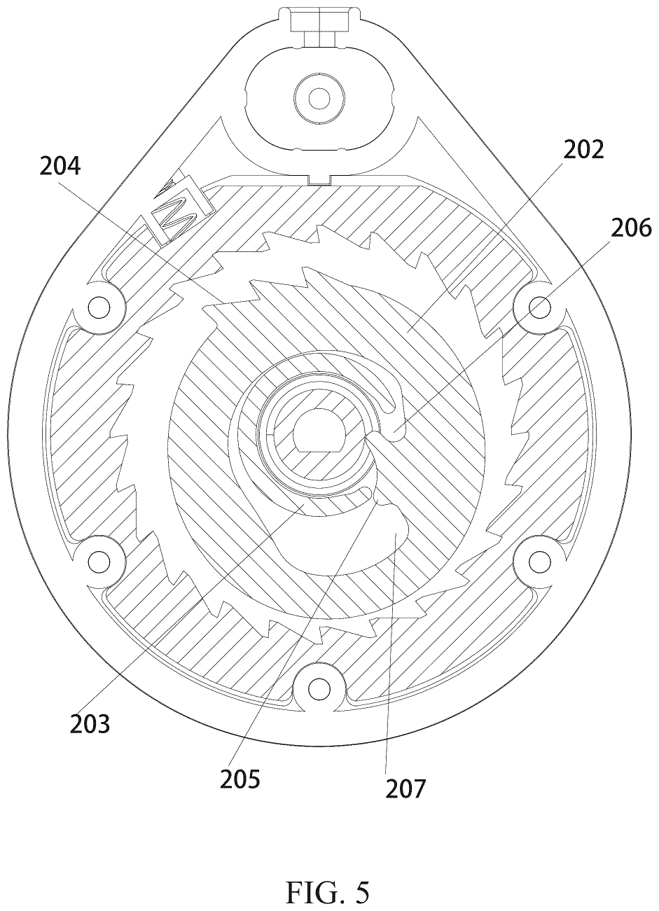

As shown in FIG. 5, the pivot member 12 pivoting slowly and uniformly towards the direction of curtain folding drives the other end of driving ring 203 to move to contact the arc-shaped portion 20 and causes part of outer wall of driving ring 203 partially contact the groove, so that the moving piece 202 pivots towards the direction of curtain folding together with the pivot member 12 in a state where the locking teeth 204 does not fit with the second ratchet groove 201;

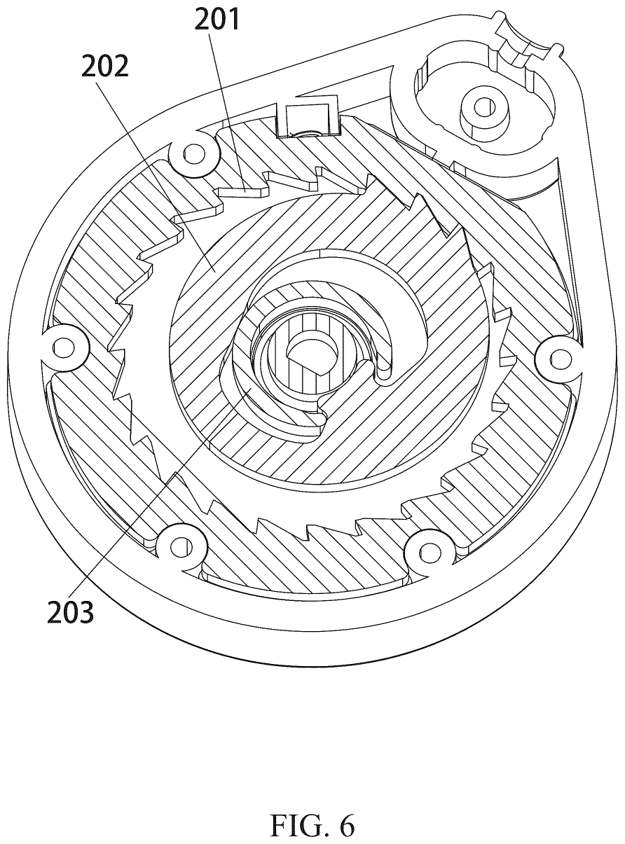

As shown in FIG. 6, when the pivot member 12 pivots in the direction of curtain folding at or beyond the predetermined pivot speed, the centrifugal force generated causes the moving piece 202 to move in the direction in which the arc-shaped portion 205 passes through the opening of driving ring 203, and the locking teeth 204 move with the movement of moving piece 202 to fit with the second ratchet groove 201 to prevent pivot member 12 from pivoting.

Specifically, the moving piece 202 is elliptical in shape, preferably made of metal.

Specifically, a second annular member having the second ratchet groove 201 is also provided, and is locked by screws or fixed in the accommodating cavity through a buckle structure, alternatively, a plurality of first limit strips are spaced apart annularly inside the accommodating cavity for insertion with the second annular member, so that the second annular member is fixed in the accommodating cavity through the insertion connection between a plurality of second limit strips and the second annular members.

Specifically, the second annular member is a sheet, preferably made of metal.

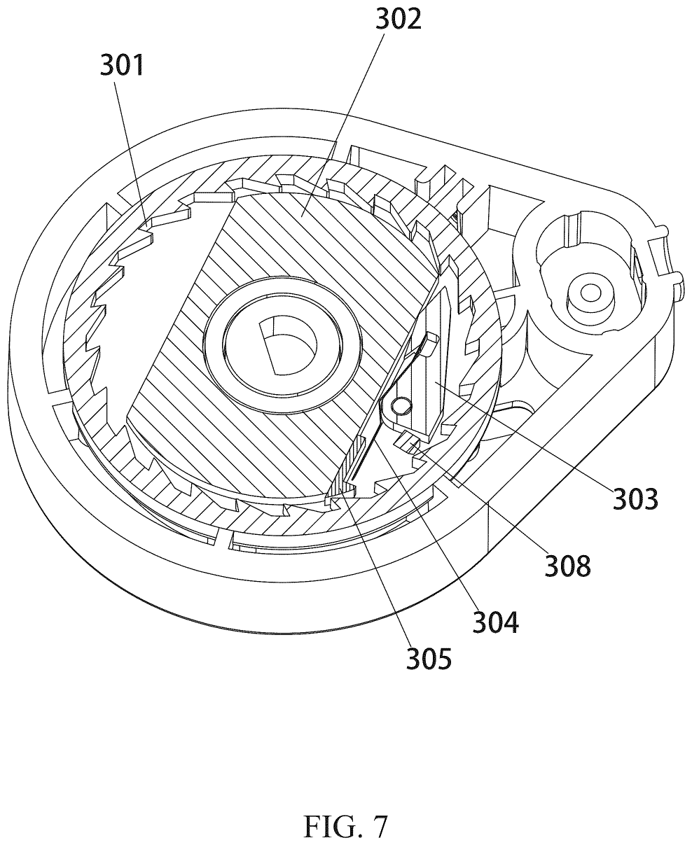

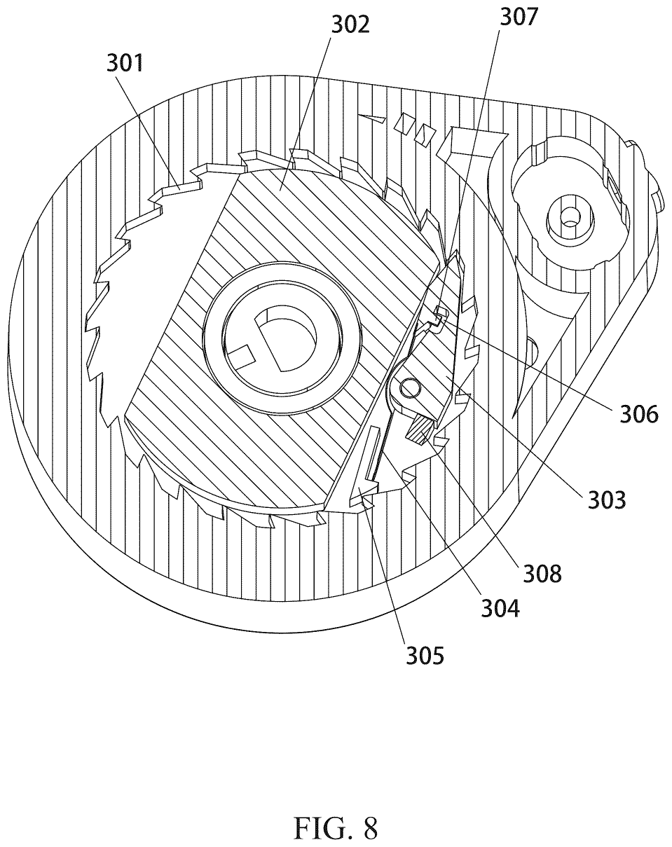

In the third embodiment, as shown in FIGS. 7 and 8, the self-locking mechanism comprises several slots 301, a counterweight block 302, a claw 303, and a second elastic member 304 that are arranged at annular intervals in the accommodating cavity;

The counterweight block 302 is pivotably installed in the accommodating cavity and coaxial with the pivot member 12;

The claw 303 is pivotably installed at a position on the bottom wall of pivot member 12 corresponding to one side of the counterweight block 302, and swings, relative to the pivot member 12, between the position where it, together with the slot 301, limits the pivot member 12 to pivot in the direction of curtain folding and the position where it contacts one end of the counterweight block 302, and the pivot member 12 is also provided with a push portion 305 for contacting the other end of the counterweight block 302;

The second elastic member 304 is used to apply elastic force to make the claw 303 move in the direction in which the claw 303 contacts the counterweight block 302;

As shown in FIG. 7, when the pivot member 12 pivots in the direction of curtain unfolding, the push portion 305 pushes the counterweight block 302 to pivot synchronously (claw 303 can move in a direction away from counterweight 302 with the pivot member 12, thus maintaining a relatively stationary state between claw 303 and counterweight 302);

As shown in FIG. 7, when the pivot member 12 pivots slowly and uniformly towards the direction of curtain folding, the claw 303 pushes the counterweight block 302 to pivot synchronously without exceeding the load of the second elastic member 304;

As shown in FIG. 8, when the pivot member 12 pivots in the direction of curtain folding at or beyond the predetermined pivot speed, the centrifugal force generated exceeds the load of the second elastic member 304, causing the claw 303 to be insufficient to push the counterweight block 302 to pivot synchronously and, in turn, due to the obstruction of the counterweight block 302, the claw 303 swings to fit with the slot 301 to prevent pivot member 12 from pivoting.

Specifically, the second elastic member 304 is a strip shaped sheet structure, the middle of the second elastic member 304 is in contact with the outer wall of the claw 303, and both ends of the second elastic member 304 are connected to the free end of the claw 303 and the side of the push portion 305 away from the counterweight block 302, respectively.

Specifically, the free end of claw 303 is provided with a connecting groove 306 having a pin portion 307, and one end of the second elastic member 304 extends into the connecting groove 306 and is fitted onto the pin portion 307 to connect with the free end of the claw 303, while the other end of the second elastic member 304 is held in contact with the push portion 305.

Specifically, the accommodating cavity is provided with a plurality of ratchet teeth at annular intervals, and the interval space between adjacent teeth is the slot 301.

Specifically, the pivot member 12 is also provided with a limit block 308, and the claw 303 can swing relative to the pivot member 12 between the position where it is in contact with the limit block 308 and the position where it is away from the limit block 308 to prevent excessive swinging of claw 303 through the limit block 308.

The present invention also proposes a telescopic door railing, comprising a lock head, a rotating drum having a torsion spring inside, a curtain body with one end connected to the rotating drum, and also a self-locking base mentioned above, and other specific contents of the self-locking base can be referenced from the above embodiments. This telescopic door railing adopting all the technical solutions of the above embodiments of the self-locking base has at least all the beneficial effects brought by the technical solutions of the above embodiments, which will not be elaborated here.

The rotating drum is pivotably installed between the lock head and the self-locking base and drives the pivot member 12 to pivot synchronously, and the torsion spring pivots along with the rotating drum in the direction of curtain unfolding to compress and store force, pivots along with the rotating drum in the direction of curtain folding to decompress, and releases the stored force at the time of decompression to make the pivot member 12 pivot at or beyond the predetermined pivot speed and, in conjunction with the self-locking mechanism, locks the pivot member 12 and rotating drum to stop the winding of the curtain body.

Specifically, the bottom of seat body 11 is pivotably provided with a first ratchet 21 and a swinging member 22, the first ratchet is connected to one end of the torsion spring and pivots relative to the seat body 11 in the direction in which the torsion spring is compressed or decompressed, and the swinging member 22 is pivotably installed at the bottom of the seat body 11 and swings between the position where it is engaged with the first ratchet and the position where it is away from the first ratchet, and the swinging member 22 engaging with the first ratchet limits the first ratchet to pivot in the direction in which elastic force is released to the torsion spring; in addition, and a first top spring 23 is also provided to apply force to make swinging member 22 swing towards the direction in which the swinging member 22 is engaged with the first ratchet wheel, the first ratchet wheel pivoting in the direction in which torsion spring is compressed overcomes the elastic force applied by the first top spring 23 to force the swinging member 22 swing in the direction away from the first ratchet.

Specifically, an adjustment hole 24 is provided on the side of the first ratchet wheel away from the pivot member 12, and the first ratchet can be driven to pivot in the direction in which the torsion spring is compressed by inserting a tool into the adjustment hole 24, thereby adjusting the compression degree of the torsion spring.

Specifically, the swinging member 22 is further provided with a driving arm 25 that drives the swinging member 22 to swing away from the first ratchet.

Specifically, the bottom of seat body 11 is provided with an installation space for accommodating the first ratchet wheel, the swinging member 22, and the first top spring 23, and the first ratchet wheel is provided with a circular table 26 having the adjustment hole 24, and a cover plate 27 is installed on the seat body 11 to close the installation space, and the cover plate 27 is open at the position corresponding to the circular table 26 and driving arm 25.

Directly driving the first ratchet wheel through the adjustment hole 24 to pivot in the direction in which the torsion spring is decompressed can reduce the compression degree of torsion spring.

When it is necessary to enhance the compression degree of torsion spring, first move the driving arm 25 through the open position of cover plate 27 to drive the swinging member 22 away from the first ratchet, and then insert a tool into the adjusting hole 24 to drive the first ratchet to pivot in the direction in which the torsion spring is compressed.

Specifically, a positioning member 31 is fixed at a position inside the rotating drum above the pivot member 12, and the positioning member 31 is pivotably provided with a sleeve 32 that is fixedly connected to the rotating drum, and the two ends of the torsion spring are fixedly connected to the positioning member 31 and pivot member 12, respectively.

Specifically, the seat body 11 is provided with a positioning rod 33 that is inserted into the rotating drum, and one end of seat body 11 is fixed with the positioning member 31, and the end of positioning rod 33 away from positioning member 31 is fixedly connected to the first ratchet wheel.

Specifically, a vertical pole 34 is further provided, the upper end of the vertical pole 34 is connected to the lock head, the lower end of vertical pole 34 is connected to the self-locking base, and the movable sleeve of vertical pole 34 is provided with a sliding seat 35, and the back of sliding seat 35 is detachably provided with a first plug board for fixed connection at the installation position.

It should be noted that the installation location described here is mainly the wall.

Specifically, the lock head comprises a housing 41, a connecting head 42 pivotably installed at the bottom, and a locking mechanism for locking the connecting head 42, the connecting head 42 is fixedly connected to the upper end of rotating drum, and the locking mechanism comprises a knob 43 pivotably installed on the housing 41, a second ratchet wheel 44 fixedly connected to the connecting head 42, a second pawl 45 pivotably installed on the housing 41, and a second top spring 46, and the second pawl 45 swings, relative to the housing 41, between the position where the second pawl 45 is engaged with the second ratchet wheel to lock the second ratchet wheel and the position where the second pawl 45 is away from the second ratchet wheel, and the second top spring 46 is used to apply elastic force to make the second pawl 45 swing in the direction in which the second pawl 45 is engaged with the second ratchet wheel, the knob 43 is provided with a driving portion 47 that swings along with the pivoting knob 43 between the position where it is away from the second pawl 45 and the position where the second pawl 45 is away from the second ratchet wheel.

Specifically, the housing 41 fits with the knob 43 through a limit structure to limit the pivot movement of knob 43 relative to the housing 41, and the knob 43 can move upward relative to the housing 41 to release the limit, or move downward to restore the limit; a tension spring 48 is also provided to apply elastic force to make the knob 43 move in the direction in which the limit can be restored; when the second ratchet wheel needs to be unlocked, the knob 43 can be lifted to release the limit fit, and then the knob 43 can be turned to unlock the second ratchet; when the knob 43 pivots to the position where the second ratchet is locked, the tension spring 48 can be used to automatically lower the knob 43 to restore the limit.

It should be noted that the limit structure can be referenced from prior art, which will not be further elaborated here.

Specifically, the back of lock head is detachably provided with a second plug board 51 for fixed connection with the installation position, and the lock head is movably installed with a moving block 52 that moves relative to the lock head between the position where it is away from the second plug board 51 and the position where it is inserted into the second plug board 51 to restrict the detachment of second plug board 51 from the lock head, and a third top spring 53 is also provided to apply elastic force to make the moving block 52 move in the direction in which moving block 52 is inserted in the second plug board 51.

It should be noted that the installation location mentioned here is mainly the wall.

Specifically, a fixed structure is also provided, comprising a snap ring 61 connected to the free end of the curtain body and a hook 62 fixedly connected to the installation position, and after the curtain body is unfolded, the free end of curtain body is fixed through the fit between the snap ring 61 and hook 62.

The present invention discloses a self-locking base and a telescopic door railing having the same, and the self-locking base is pivotably provided with a pivot member that is fixedly connected to a rotating drum, and is also provided with a self-locking mechanism which locks the pivot member through the self-locking base when the pivot member rotates in the direction of curtain folding at or beyond a predetermined speed. Compared with traditional ones, the present invention adds a self-locking function on the basis of prior art, and when the rotating drum pivots in the direction of curtain folding, the torsion spring is decompressed to release elastic force to make the rotating drum and pivot member reach or exceed the predetermined speed, and to trigger the self-locking mechanism to lock the pivot member, thereby stopping the automatic folding of curtain body and effectively avoiding the injury to the human body caused by the swinging curtain during the automatic folding process, or damage to the curtain body caused by collision with hard or sharp objects during swinging.

The above are only the preferred embodiments of the present invention, and are not intended to limit the present invention. Any equivalent structural transformation made based on the description and accompanying drawings hereof under the concept of present invention, or be directly/indirectly applied in other related technical fields, should fall within scope of patent protection of the present invention.

What is claimed is:

1. A self-locking base, comprising:
a seat body (11);
a pivot member (12) that is pivotably installed on the seat body (11) and pivots relative to the seat body (11) in the direction of curtain unfolding or folding;
a self-locking mechanism that is provided on the seat body (11) for locking the pivot member (12) when the pivot member (12) pivots at or beyond a predetermined pivot speed in the direction of curtain unfolding.

2. The self-locking base according to claim 1, wherein the seat body is provided with a top open accommodating cavity, the self-locking mechanism is disposed in the accommodating cavity, and the bottom of pivot member (12) is pivotably installed in the accommodating cavity to close the top opening of accommodating cavity.

3. The self-locking base according to claim 2, wherein the self-locking mechanism comprises a first ratchet groove (101), a first pawl (102), and a first elastic member (103) that are disposed in the accommodating cavity;
the first pawl (102) is rotatably mounted at a position on the bottom wall of pivot member (12) corresponding to the first ratchet groove (101), and the first pawl (102) swings relative to pivot member (12) between the position where it is engaged with the first ratchet groove (101) and the position where it is away from the first ratchet groove (101);
one end of the first elastic member (103) is fixed, and the other end is connected to the free end of first pawl (102), and when the pivot member (12) pivots in the direction of curtain folding at or beyond the predetermined pivot speed, the centrifugal force generated exceeds the load of the first elastic member (103), so that the first pawl (102) swings to fit with the first ratchet groove (101) to make the pivot member (12) pivot in the direction of curtain folding, while causing local deformation of the first elastic member (103) and applying elastic force to make the first pawl (102) swing away from the direction of ratchet groove.

4. The self-locking base according to claim 3, wherein the bottom wall of pivot member (12) is pivotably installed with a pair of the first claws (102).

5. The self-locking base according to claim 3, wherein an avoidance groove (104) is provided between the two ends of the first pawl (102), and a holder (105) is provided at the position on the bottom wall of pivot member (12) corresponding to the avoidance groove (104), and one end of the first elastic member (103) is connected to the holder (105), and the other end is connected to the free end of the first pawl (102).

6. The self-locking base according to claim 5, wherein the bottom wall of pivot member (12) is further provided with a pressing portion (106) at the position corresponding to the avoidance groove (104), the holder (105) is L-shaped, and the two sides of the first elastic member (103) are respectively in contact with the holder (105) and the pressing portion (106) to fix the first elastic member (103).

7. The self-locking base according to claim 5, wherein the free end of first pawl (102) is provided with a slit for the movable insertion of the end of the first elastic member (103).

8. The self-locking base according to claim 3, wherein the first elastic member (103) is a strip shaped sheet structure.

9. The self-locking base according to claim 2, wherein the self-locking mechanism comprises a second ratchet groove (201), a moving piece (202), and a partially open driving ring (203) that are disposed in the accommodating cavity;
the driving ring (203) is located on the bottom wall of pivot member (12) and is coaxial with the pivot member (12);
the outer edge of moving piece (202) is provided with several locking teeth (204) that fit with the second ratchet groove (201), the moving piece (202) is movably disposed in the second ratchet groove (201) and moves between the position where the locking teeth (201) is engaged with the second ratchet groove (201) and the position where the locking teeth (201) is away from the second ratchet groove (201), and the moving piece (202) is also provided with a groove for the insertion of driving ring (203), the groove is provided with an arc-shaped portion (205) that passes through the opening of driving ring (203), and the two ends of the arc-shaped portion (205) fit with the inner wall of the groove to respectively form a first locking position (206) and a second locking position (207);
the pivot member (12) pivoting in the direction of curtain unfolding drives one of the two ends of the driving ring (203) to enter the first lock position (206) and maintain contact to drive the moving piece (202) to move in the direction in which the second ratchet groove (201) exits the locking teeth (204) and partially contact the groove along with the local outer wall of driving ring (203), so that the moving piece (202) pivots in the direction of curtain unfolding together with the pivot member (12) in the state where the locking teeth (204) does not fit with the second ratchet groove (201);
the pivot member (12) pivoting slowly and uniformly towards the direction of curtain folding drives the other end of driving ring (203) to move to contact the arc-shaped portion (205) and causes part of outer wall of driving ring (203) partially contact the groove, so that the moving piece (202) pivots towards the direction of curtain folding together with the pivot member (12) in a state where the locking teeth (204) does not fit with the second ratchet groove (201);
when the pivot member (12) pivots in the direction of curtain folding at or beyond the predetermined pivot speed, the centrifugal force generated causes the moving piece (202) to move in the direction in which the arc-shaped portion (205) passes through the opening of driving ring (203), and the locking teeth (204) move with the movement of moving piece (202) to fit with the second ratchet groove (201) to prevent pivot member (12) from pivoting.

10. The self-locking base according to claim 9, wherein the moving piece (202) is elliptical in shape.

11. The self-locking base according to claim 2, wherein the self-locking mechanism comprises several slots (301), a counterweight block (302), a claw (303), and a second elastic member (304) that are arranged at annular intervals in the accommodating cavity;
the counterweight block (302) is pivotably installed in the accommodating cavity and coaxial with the pivot member (12);
the claw (303) is pivotably installed at a position on the bottom wall of pivot member (12) corresponding to one side of the counterweight block (302), and swings, relative to the pivot member (12), between the position where it, together with the slot (301), limits the pivot member (12) to pivot in the direction of curtain folding and the position where it contacts one end of the counterweight block (302), and the pivot member (12) is also provided with a push portion (305) for contacting the other end of the counterweight block (302);
the second elastic member (304) is used to apply elastic force to make the claw (303) move in the direction in which the claw (303) contacts the counterweight block (302);
when the pivot member (12) pivots in the direction of curtain unfolding, the push portion (305) pushes the counterweight block (302) to pivot synchronously;
when the pivot member (12) pivots slowly and uniformly towards the direction of curtain folding, the claw (303) pushes the counterweight block (302) to pivot synchronously without exceeding the load of the second elastic member (304);
when the pivot member (12) pivots in the direction of curtain folding at or beyond the predetermined pivot speed, the centrifugal force generated exceeds the load of the second elastic member (304), causing the claw (303) to be insufficient to push the counterweight block (302) to pivot synchronously and, in turn, due to the obstruction of the counterweight block (302), the claw (303) swings to fit with the slot (301) to prevent pivot member (12) from pivoting.

12. The self-locking base according to claim 11, wherein the second elastic member (304) is a strip shaped sheet structure, the middle of the second elastic member (304) is in contact with the outer wall of the claw (303), and both ends of the second elastic member (304) are connected to the free end of the claw (303) and the side of the push portion (305) away from the counterweight block (302), respectively.

13. The self-locking base according to claim 11, wherein the accommodating cavity is provided with a plurality of ratchet teeth at annular intervals, and the interval space between adjacent teeth is the slot (301).

14. A telescopic door railing, comprising a lock head, a rotating drum having a torsion spring inside, and a curtain body with one end connected to the rotating drum, further comprising a self-locking base as claimed in claim 1, the rotating drum is pivotably installed between the lock head and the self-locking base and drives the pivot member (12) to pivot synchronously, and the torsion spring pivots along with the rotating drum in the direction of curtain unfolding to compress and store force, pivots along with the rotating drum in the direction of curtain folding to decompress, and releases the stored force at the time of decompression to make the pivot member (12) pivot at or beyond the predetermined pivot speed.

15. The self-locking base according to claim 14, wherein the bottom of seat body (11) is pivotably provided with a first ratchet (21) and a swinging member (22), the first ratchet is connected to one end of the torsion spring and pivots relative to the seat body (11) in the direction in which the torsion spring is compressed or decompressed, and the swinging member (22) is pivotably installed at the bottom of the seat body (11) and swings between the position where it is engaged with the first ratchet and the position where it is away from the first ratchet, and the swinging member (22) engaging with the first ratchet limits the first ratchet to pivot in the direction in which elastic force is released to the torsion spring; in addition, a first top spring (23) is provided to apply force to make swinging member (22) swing towards the direction in which the swinging member (22) is engaged with the first ratchet wheel, the first ratchet wheel pivoting in the direction in which torsion spring is compressed overcomes the elastic force applied by the first top spring (23) to force the swinging member (22) swing in the direction away from the first ratchet.

16. The self-locking base according to claim 15, wherein an adjustment hole (24) is provided on the side of the first ratchet wheel away from the pivot member (12).

17. The self-locking base according to claim 16, wherein the swinging member (22) is further provided with a driving arm (25) that drives the swinging member (22) to swing away from the first ratchet.

18. The self-locking base according to claim 17, wherein the bottom of seat body (11) is provided with an installation space for accommodating the first ratchet wheel, the swinging member (22), and the first top spring (23), and the first ratchet wheel is provided with a circular table (26) having the adjustment hole (24), and a cover plate (27) is installed on the seat body (11) to close the installation space, and the cover plate (27) is open at the position corresponding to the circular table (26) and driving arm (25).

19. The telescopic door railing according to claim 15, wherein a positioning member (31) is fixed at a position inside the rotating drum above the pivot member (12), and the positioning member (31) is pivotably provided with a sleeve (32) that is fixedly connected to the rotating drum, and the two ends of the torsion spring are fixedly connected to the positioning member (31) and pivot member (12), respectively.

20. The telescopic door railing according to claim 19, wherein the seat body (11) is provided with a positioning rod (33) that is inserted into the rotating drum, and one end of seat body (11) is fixed with the positioning member (31), and the end of positioning rod (33) away from positioning member (31) is fixedly connected to the first ratchet wheel.

21. The telescopic door railing according to claim 14, wherein a vertical pole (34) is further provided, the upper end of the vertical pole (34) is connected to the lock head, the lower end of vertical pole (34) is connected to the self-locking base, and the movable sleeve of vertical pole (34) is provided with a sliding seat (35), and the back of sliding seat (35) is detachably provided with a first plug board for fixed connection at the installation position.

22. The telescopic door railing according to claim 14, wherein the lock head comprises a housing (41), a connecting head (42) pivotably installed at the bottom, and a locking mechanism for locking the connecting head (42), the connecting head (42) is fixedly connected to the upper end of rotating drum, and the locking mechanism comprises a knob (43) pivotably installed on the housing (41), a second ratchet wheel (44) fixedly connected to the connecting head (42), a second pawl (45) pivotably installed on the housing (41), and a second top spring (46), and the second pawl (45) swings, relative to the housing (41), between the position where the second pawl (45) is engaged with the second ratchet wheel to lock the second ratchet wheel and the position where the second pawl (45) is away from the second ratchet wheel, and the second top spring (46) is used to apply elastic force to make the second pawl (45) swing in the direction in which the second pawl (45) is engaged with the second ratchet wheel, the knob (43) is provided with a driving portion (47) that swings along with the pivoting knob (43) between the position where it is away from the second pawl (45) and the position where the second pawl (45) is away from the second ratchet wheel.

23. The telescopic door railing according to claim 14, wherein the back of lock head is detachably provided with a second plug board (51) for fixed connection with the installation position, and the lock head is movably installed with a moving block (52) that moves relative to the lock head between the position where it is away from the second plug board (51) and the position where it is inserted into the second plug board (51) to restrict the detachment of second plug board (51) from the lock head, and a third top spring (53) is also provided to apply elastic force to make the moving block (52) move in the direction in which moving block (52) is inserted in the second plug board (51).

24. The telescopic door railing according to claim 14, a fixed structure is also provided, comprising a snap ring (61) connected to the free end of the curtain body and a hook (62) fixedly connected to the installation position, and after the curtain body is unfolded, the free end of curtain body is fixed through the fit between the snap ring (61) and hook (62).
